(19) United States
(12) Patent Application Publication
(10) Pub. No.: US 2009/0034615 A1
(43) Pub. Date: Feb. 5, 2009

(54) DECODING DEVICE AND DECODING METHOD

(75) Inventor: Katsuhisa Yano, Hachioji-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/141,657

(22) Filed: Jun. 18, 2008

(30) Foreign Application Priority Data
Jul. 31, 2007 (JP) 2007-199545

(51) Int. Cl. H04N 7/32

(52) U.S. Cl. 375/240.12; 375/E07.243

(57) ABSTRACT

According to one embodiment, a decoding device, includes an input unit configured to input a moving image stream wherein each image is encoded in macro-blocks of n×n pixels to be generated by being divided in a matrix shape, a detection unit configured to analyze information of a slice composed of more than one macro-block included in the moving image stream input from the input unit and detects inter-macro-blocks in the slice, two or more decoding units configured to decode the moving image stream in macro-blocks, and a control unit configured to make the decoding unit decode intra-macro-blocks in the slice after making the two or more decoding units decode in parallel the inter-macro-blocks in the slice detected by the detection unit.

### CROSS-REFERENCE TO RELATED APPLICATIONS

This application is based upon and claims the benefit of priority from Japanese Patent Application No. 2007-199545, filed Jul. 31, 2007, the entire contents of which are incorporated herein by reference.

### BACKGROUND

1. Field

One embodiment of the present invention is relates to a decoding technique of a moving image stream which is appropriate for applying to a decoding device such as a personal computer.

2. Description of the Related Art

In general, personal computers having audio video (AV) functions which are the same as those of digital versatile disc (DVD) players, television receivers, etc, have become widely used. Such personal computers have used software decoders for decoding encoded moving image streams by using software. Using the software decoders enables CPUs to decode the encoded moving image streams without having to be separately provided with exclusive hardware.

Recently, the H.264/advanced video coding (AVC) standard has been widely noticed as the next generation moving image coding technique. The H.264/AVC standard is an encoding technique with efficiency higher than the conventional MPEG 2 and MPLEG 4. Therefore, in each of encode processing and decode processing corresponding to the H.264/AVC standard, processing amounts which are larger than those of the MPEG 2 and MPEG 4 are needed.

Therefore, a personal computer, which has been designed so as to decode the moving image stream encoded by the H.264/AVC standard by means of the software, requires, for example, efficiency such that a plurality of pieces of processing are executed in parallel as much as possible. Thus, a proposal for executing decoding the moving image streams in parallel has been presented (e.g., refer to Jpn. Pat. Appln. KOKAI Publication No. 2006-129285).

The decoding device disclosed in Jpn. Pat. Appln. KOKAI Publication No. 2006-129285 has a scheme of macro-block processing agent for managing processing state of each macro-block by taking the case in which there are dependency relations among periphery macro-blocks at the upper left, upper, right upper and left direction in the signal processing based on the H.264/AVC standard. That is, the foregoing scheme performs the macro-block processing while scanning a state in which processing is enabled (in parallel if possible).

However, this method is complicated in procedure, and since the method is in danger of increasing a system load, a scheme capable of executing decoding the moving image stream in parallel by a simpler procedure has been strongly required.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view illustrating an external appearance of a computer regarding one embodiment of the invention;

FIG. 2 is an exemplary view illustrating a system configuration of a computer of the embodiment;

FIG. 3 is an exemplary functional block diagram of a decoder function owned by a video reproduction application program to be used by the computer of the embodiment;

FIG. 4 is an exemplary pattern diagram illustrating dependency relations to periphery macro-blocks;

FIG. 5 is an exemplary view for explaining decoding processing to be executed by the video reproduction application program of the embodiment;

FIG. 6 is an exemplary schematic view illustrating a configuration of a moving image stream encoded by an encoding system defined by the H.264/AVC standard;

FIG. 7 is an exemplary pattern diagram for explaining a detection principle of macro-blocks of the embodiment; and

FIG. 8 is an exemplary flowchart illustrating a procedure of decoding processing of the embodiment.

### DETAILED DESCRIPTION

Various embodiments according to the invention will be described hereinafter with reference to the accompanying drawings. In general, according to one embodiment of the invention, a decoding device, includes: an input unit which inputs a moving image stream wherein each image is encoded in macro-blocks of n×n pixels to be generated by being divided in a matrix shape; a detection unit which analyzes information of a slice composed of more than one macro-block included in the moving image stream input from the input unit and detects inter-macro-blocks in the slice; two or more decoding processing units which execute decoding processing in macro-blocks; and a control unit which makes the decoding processing unit execute decoding processing of intra-macro-blocks in the slice after making the two or more decoding processing units execute in parallel the decoding processing of the inter-macro-blocks in the slice detected by the detection unit.

Hereinafter, embodiments of the invention will be described with reference to the drawings.

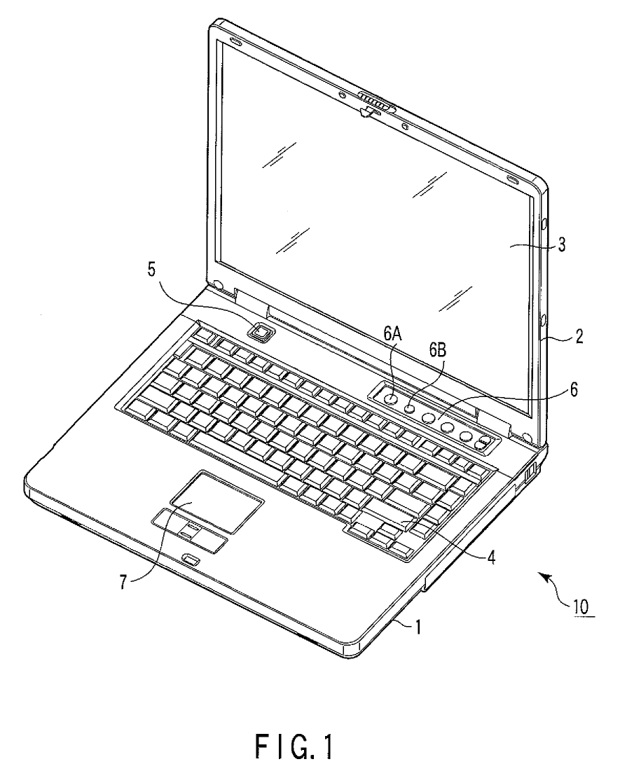

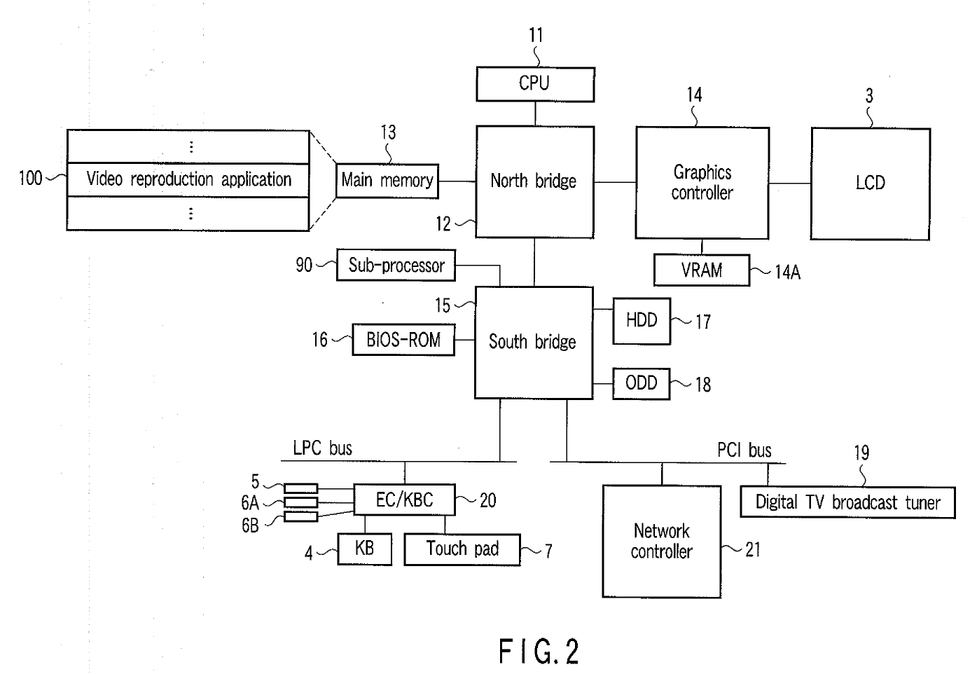

Firstly, a configuration of a decoding device regarding the embodiment of the invention will be described by referring to FIGS. 1, 2. The decoding device is actualized, for example, as a notebook-sized personal computer 10.

FIG. 1 shows a perspective view in a state in which a display unit of the computer 10 is open. The computer 10 consists of a computer main unit 1 and a display unit 2. The display unit 2 has a display device composed of a liquid crystal display (LCD) 3 built-in, and a display screen of the LCD 3 is positioned at the approximate center of the display unit 2.

The display unit 2 is attached to the main unit 1 so as to freely rotate between an open position and a closed position. The main unit 1 has a thin box-type housing, a keyboard 4, a power button 5 for turning on/off a power source to the computer 10, an input operation panel 6, and a touch pad 7, etc.

The operation panel 6 is an input device to input an event, corresponding to a depressed button, in a system, and has a plurality of buttons to each start up a plurality of functions. A button group includes a TV start-up button 6A and a DVD start-up button 6B. The TV start-up button 6A is a button to start up a TV function for reproducing and recording broadcast program data such as a digital TV broadcast program. When the TV start-up button 6A is depressed by a user, a TV application program to execute the TV function is started. The DVD start-up button 6B is a button to reproduce video content recorded on a DVD, and when the DVD start-up button 6B is depressed by the user, an application program to reproduce the video content is automatically started up.

Next, the system configuration of the computer 10 will be described with reference to FIG. 2.

The computer 10, as shown in FIG. 2, includes a CPU 11, a north bridge 12, a main memory 13, a graphics controller 14, a south bridge 15, a basic input output system (BIOS)-ROM 16, a hard disk drive (HDD) 17, an optical disk drive (ODD) 18, a digital TV broadcast tuner 19, an embedded controller/keyboard controller IC (EC/KBC) 20, a network controller 21, and a sub-processor 90.

The CPU 11 is a processor to be disposed in order to control operations of the computer 10, and executes various application programs such as an operation system (OS) and a video reproduction application program 100 to be loaded in the main memory 13 from the HDD 17.

The sub-processor 90 is hardware to decode and reproduce encoded moving image data. The sub-processor 90 is a hardware decoder corresponding to the H.264/AVC standard. The sub-processor 90 has a decoding function for decoding a moving image stream (e.g., a digital TV broadcast program to be received by a digital TV broadcast tuner and video content of the high definition [HD] standard read from the ODD 18) encoded by an encoding system defined by the H.264/AVC standards.

The CPU 11 also executes a BIOS stored in the BIOS-ROM 16. The BIOS is a program to control hardware.

The north bridge 12 is a bridge device for connecting between a local bus of the CPU 11 and the south bridge 15. The north bridge 12 also has a memory controller to control access to the main memory 13 built-in. The north bridge 12 also has a function of executing communication with the graphics controller 14 via an accelerated graphics port (AGP) bus, etc.

The graphics controller 14 is a display controller for controlling an LCD 3 to be used as a display monitor of the computer 10. The graphics controller 14 generates a display signal to be sent to the LCD 3 from the image data written on a video memory (VRAM) 14A.

The south bridge 15 controls each device on a low pin count (LPC) and each device on a peripheral component interconnect (PCI) bus. The south bridge 15 has an integrated drive electronics (IDE) controller for controlling the HDD 17 and ODD 18 built-in. Further, the south bridge 15 also has a function of controlling the digital broadcast tuner 19 and a function of controlling access to the BIOS-ROM 16.

The HDD 17 is a storage device for storing a variety of kinds of software and data. The ODD 18 is a drive unit for driving a recording medium such as a DVD with video content recorded thereon. The broadcast tuner 19 is a receiving device for externally receiving broadcast program data such as a digital TV broadcast program.

The EC/KBC 20 is a one-chip microcomputer with an embedded controller to manage power, and a keyboard controller to control a keyboard (KB) 4 and a touch pad 7 integrated therein. The EC/KBC 20 includes a function of turning on/off a power source of the computer 10 in response to an operation of a power button 5 by the user. Further, the EC/KBC 20 also may turn on/off the power source of the computer 10 in response to the operation of the TV start-up button 6A and the DVD start-up button 6B by the user. The network controller 21 is a communication device for executing communications with an external network, for example, the Internet.

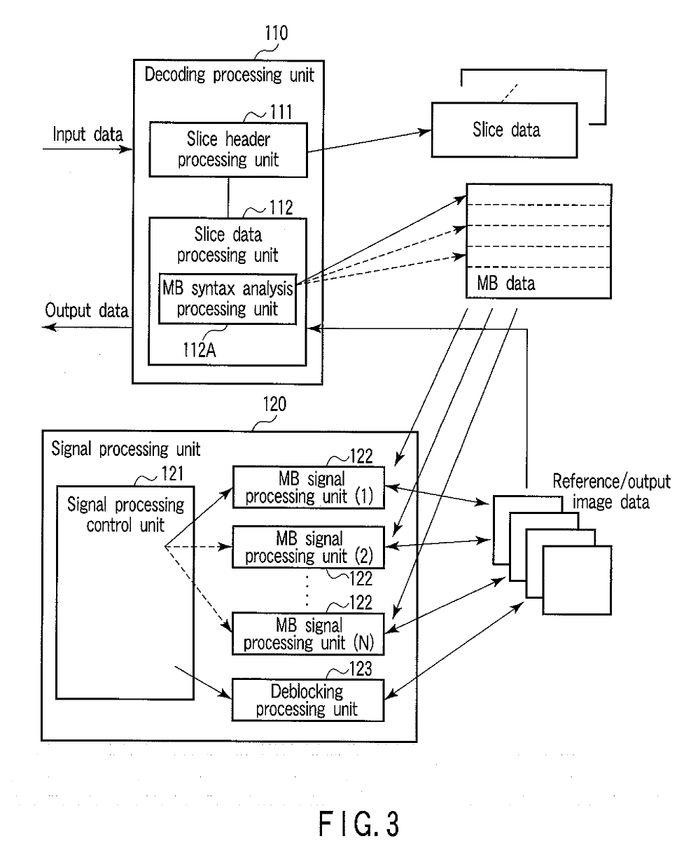

FIG. 3 shows a functional block diagram of the decoder function owned by the sub-processor 90 operating on the computer 10 with the forgoing configuration.

The sub-processor 90 has a decoding processing unit 110 and a signal processing unit 120 as shown in FIG. 3.

The TV broadcast program received from the tuner 19 and the video content (moving image stream encoded by the encoding system defined by H.264/AVC standard) of the HD standard read from the ODD 18 are signals which have been processed by the H.264/AVC standard. In the moving image stream based on the H.264/AVC standard, each stream consists of a plurality of pictures and each picture is composed of more than one slice. Each slice is composed of more than one micro block, and each macro-block has a size of n×n pixels. The decoding processing unit 110 performs decoding processing, for example, for each macro-block.

There are two kinds of macro-blocks, which are an inter-macro-block performing an inter-prediction and an intra-macro-block performing an intra-prediction. Since the inter-macro-block encoded through the inter-prediction (also called an inter-picture prediction or an inter-frame prediction) refers to other macro-blocks in other frame, the inter-macro-blocks may be decoded after decoding the frame.

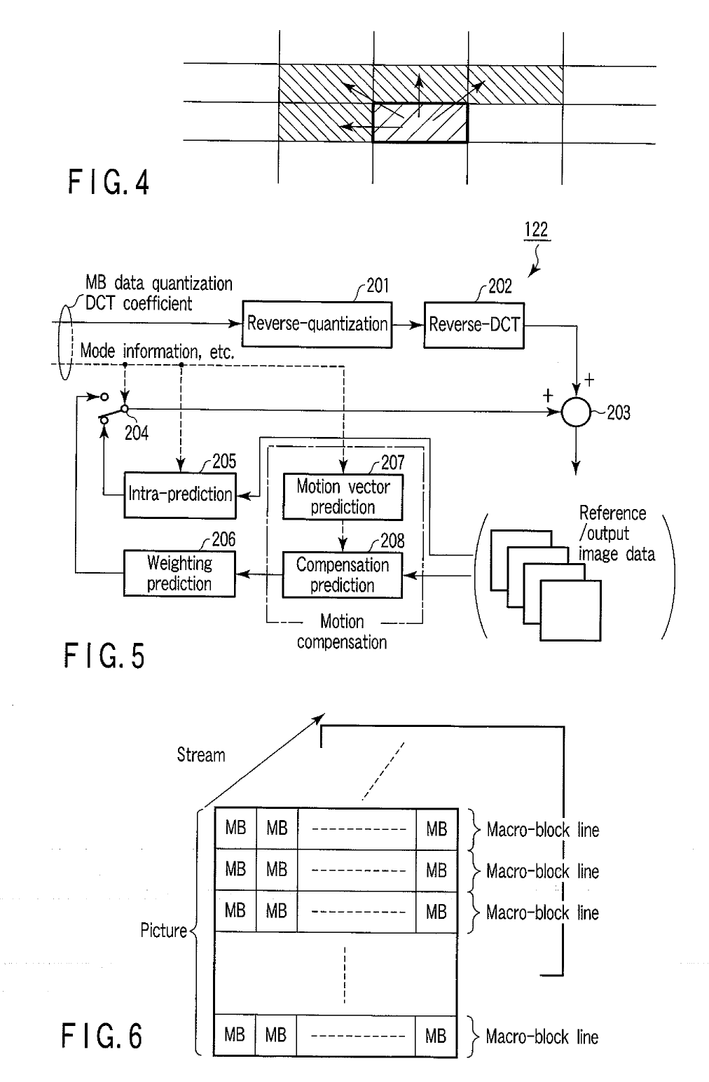

Meanwhile, the intra-macro-blocks encoded through the intra-prediction (also called intra-picture prediction) refers to other macro-block in the picture then may be decoded after decoding other macro-block. FIG. 4 shows the dependency relations. The intra-macro-blocks may refer to the periphery macro-blocks at the upper left, upper, right upper and left direction. In other words, the intra-macro-block may not be accurately decoded without decoding the macro-blocks at the upper left, upper, right upper and left direction.

By taking such dependency relations into account, a slice header processing unit 111 of the decoding processing unit 110 analyzes the slice header on the basis of syntax information, and it is determined whether the slice header is the inter-macro-block or the intra-macro-block. In the H.264/AVC standard, each picture is encoded in macro-blocks, for example, of 16×16 pixels, the slice is composed of a macro-block line more than one (usually, composed of macro-block lines of one picture). The slice has a header part (slice header) and a data part (slice data).

A slice data processing unit 112 of the decoding processing unit 110 analyzes the slice data to divide into individual macro-blocks (MBs). A macro-block syntax analysis processing unit 112A of the slice data processing unit 112 executes syntax analysis for acquiring a quantization DCT coefficient, mode information showing that which of an intra-frame encoding mode (intra-encoding mode) and movement compensation inter-frame prediction encoding mode (inter-encoding mode) has encoded each macro-block, and vector information used for inter-encoding for each macro-block.

The signal processing unit 120 applies decoding processing to the data which has been divided into macro-block units by means of the decoding processing unit 110. The signal processing control unit 121 controls the entire of the signal processing unit 120, a plurality of macro-block signal processing units 122 each execute decoding processing in macro-blocks. A deblocking processing unit 123 executes deblocking filter processing in order to reduce block distortion for the macro-blocks decoded by the macro-block signal processing unit 122. A decoder function owned by the video reproduction application program 100 of the embodiment provides the plurality of macro-block signal processing units 122 for the signal processing unit 120, detects the inter-macro-blocks in the slice data, and applies the decoding processing to the detected inter-macro blocks before applying the decoding processing to the intra-macro-blocks. At this moment, the decoder function may perform the decoding processing in parallel with each other then the following will describe this point in detail.

At first, the decoding processing to be each executed by the plurality of macro-block signal processing unit 122s will be described by referring to FIG. 5.

The macro-block signal processing unit 122 corresponds to the H.264/AVC standard, and includes a reverse-quantization unit 201, a reverse-discrete cosine transform (DOCT) 202, an adding unit 203, a mode change switch unit 204, an intra-prediction unit 205, a weighting prediction unit 206, a motion vector prediction unit 207, and a compensation prediction unit 208, as shown in FIG. 5. Orthogonal conversion by the H.264/AVC standard produces integer precision and differs from the conventional DCT; however the orthogonal conversion is referred to as a DOCT here.

The quantization DOCT coefficient, mode information, motion vector information and intra-frame prediction information which have been acquired by the syntax analysis by the macro-block syntax analysis processing unit 112A of the slice data processing unit 112 are transmitted to the reverse-quantization unit 201, mode change switch unit 204, motion vector prediction unit 207 and intra-prediction unit 205, respectively.

The quantization OCT coefficient of 16×16 of each macro-block is converted into the DOCT coefficient (orthogonal conversion coefficient) of 16×16 through reverse-quantization processing by means of the reverse-quantization unit 202. The DCT coefficient of 16×16 is converted into a pixel value of 16×16 from frequency information by the reverse-integer DCT (reverse-orthogonal conversion) processing by the reverse-DOCT unit 202. The pixel value of 16×16 is a prediction error signal corresponding to the macro-block. The prediction error signal is transmitted to the adding unit 203, the prediction signal (motion compensation inter-frame prediction signal or intra-frame prediction signal) corresponding to the macro-block is added there, and the pixel value of 16×16 corresponding to the macro block is decoded.

In the intra-encoding mode, since the prediction signals are generated from each picture to be encoded, and the prediction signals are encoded by the orthogonal conversion (DCT), quantization and entropy encoding, the intra-prediction unit 205 is selected by the mode change switch unit 204, thereby, the intra-frame prediction signal from the intra prediction unit 205 is added to the prediction error signal.

In contrast, in the inter-encoding mode, the motion compensation inter-frame prediction signal corresponding to the picture to be encoded is generated for each predetermined shape, and the prediction error signal produced by subtracting the concerned motion compensation inter-frame prediction signal from each picture to be encoded is encoded through the orthogonal conversion (DCT), quantization and entropy encoding, the weighting prediction unit 206 is selected by means of the mode change switch unit 204. Therefore, the motion compensation inter-frame prediction signal which has been obtained by the motion vector prediction unit 207, the compensation prediction unit 208 and the weighting prediction unit 206 are added to the prediction error signal.

The intra-prediction unit 205 generates intra-frame prediction signals of the block to be decoded included in the picture from the picture to be decoded. The intra-prediction unit 205 executes intra-picture prediction processing in accordance with the foregoing intra-frame prediction information, and generates the intra-frame prediction signal from the pixel values in other blocks which are adjacent to the blocks to be decoded and which have been already decoded. The intra-prediction is a technique for enhancing a compression rate by using inter-block pixel association.

Meanwhile, the motion vector prediction unit 207 generates the motion vector information on the basis of the motion vector difference information corresponding to the block to be decoded. The compensation prediction Unit 208 generates the motion compensation intra-frame prediction signal from the pixel group with integer precision and from the prediction compensation pixel group with ¼ pixel precision in the reference picture. The weighting prediction unit 206 generates the weighted motion compensation intra-frame prediction signal by executing the processing for multiplying the weight coefficient to the motion compensation intra-frame prediction signal for each compensation block. The weighting prediction is processing for predicting the brightness of the picture to be decoded. With this weighting prediction processing, image quality of the image, of which the brightness is varied with the elapse of time like fade-in and fade-out, may be improved.

Like this, each macro-block signal processing unit 122 adds the prediction signal (motion compensation inter-frame prediction signal or intra-frame prediction signal) to the prediction error signal corresponding to the picture to be decoded, and executes the processing to decode the picture to be decoded for each macro-block.

Meanwhile, as mentioned above, the decoding processing for the macro-block encoded in the intra-encoding mode uses the intra-frame prediction signal. In contrast, the decoding processing for the macro-block encoded in the inter-encoding mode uses the motion compensation intra-frame prediction signal. In other words, although there are dependency relations among macro-blocks in the intra-encoding mode and the periphery macro-blocks (in the same picture) (refer to FIG. 4); there is no dependency relation among the macro-blocks in the inter-encoding mode and the periphery macro-blocks. That is, each macro-block in the slice has no dependency on decoding order, may be decoded in parallel. Therefore, firstly, the signal processing control unit 121 of the signal processing unit 120 detects the macro-blocks (inter-macro-blocks) of the inter-encoding mode from slice data composed of a plurality of macro-blocks on the basis of the mode information acquired by the analysis from the slice data processing unit 112 of the decoding processing unit 110. Secondarily, the signal processing control unit 121 of the signal processing unit 120 performs decoding processing in parallel only of the detected inter-macro-blocks. After this, the signal processing control unit 121 decodes the intra-macro-blocks.

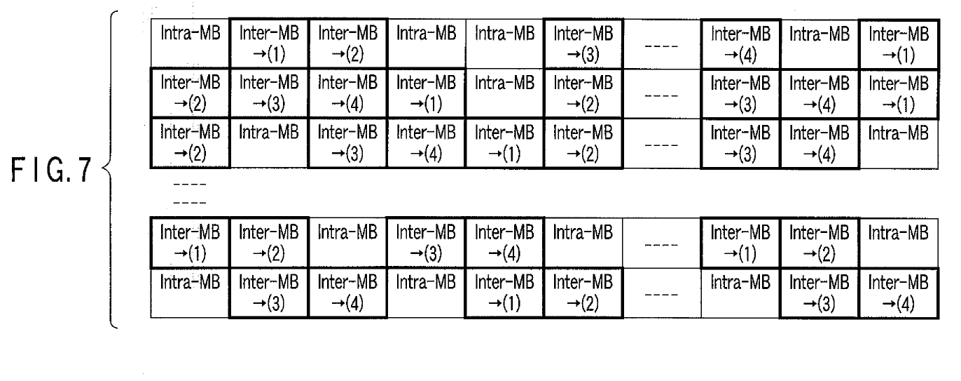

FIG. 6 shows a schematic view depicting a structure of a moving image stream which has been encoded by the encoding system defined by the H.264/AVC standard. As shown in FIG. 6, each picture is encoded in macro-blocks, for example, of 16×16 pixels generated by dividing in a matrix shape. For decoding the moving image stream which has been encoded as mentioned above, the signal processing unit 121 of the signal processing unit 120 detects only the inter-macro-blocks (inter-MBs) as shown in FIG. 7. The detection refers to syntax.

The signal processing control unit 121 executes in parallel the decoding processing for the detected inter-MBs by using the plurality of macro-block signal processing unit 122, for instance, in order of 1, 2, 3, . . . , by assigning numerical figures.

The signal processing control unit 121 makes the macro-block signal processing unit 122 start the decoding processing of the next slice at the timing of termination of decoding processing up to the end of a certain slice.

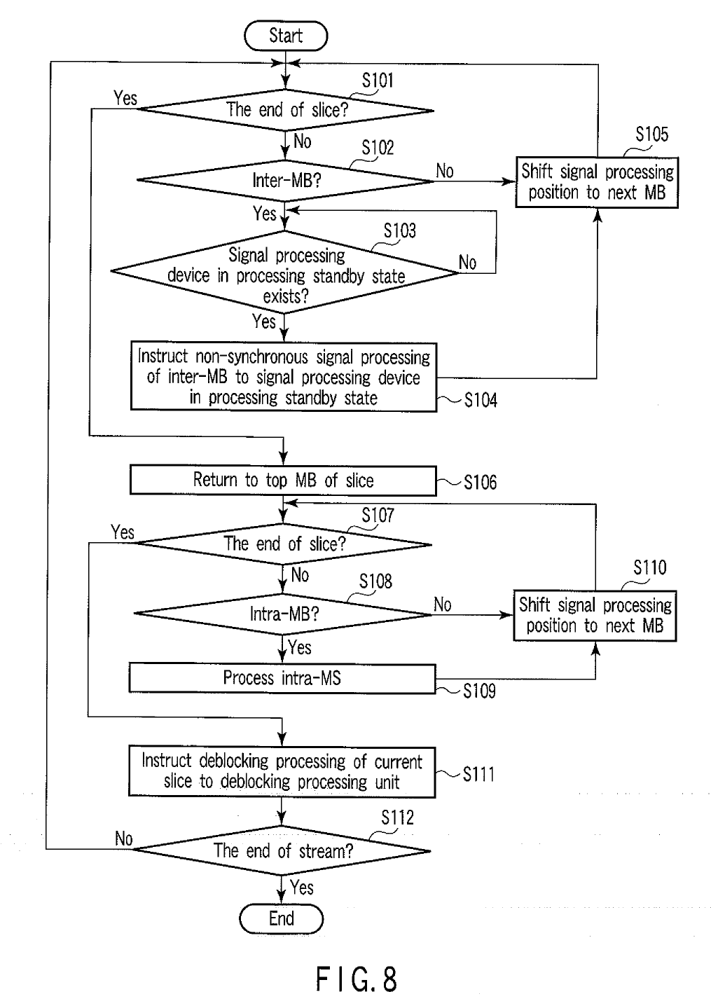

Next, the procedure of decoding processing to be executed by the signal processing unit 120 of the sub-processor 90 will be described with reference to the flowchart of FIG. 8.

The signal processing control unit 121 reads a predetermined slice, and if it is not the end of the slice (NO, Block S101), signal processing control unit 121 determines whether or not the macro-block is the inter-MB (Block S102). If the control unit 121 determines that the macro-block is the inter-MB (YES in Block S102), the control unit 121 detects the determined inter-MB as shown in FIG. 7 and assigns processing order. If the control unit 121 determines that the MB signal processing unit 122 in a processing standby state exists (YES in Block S103), instructs non-synchronous signal processing of the inter-MB to the MB signal processing unit 122 in a standby state (Block S104). Next, the control unit 121 sifts the signal processing position to the next MB (Block S105), and continues processing up to the end of the slice.

In Block S101, if the control unit 121 determines the end of the slice (YES in Block S101), the control unit 121 returns to the MB at the top of the slice (Block S106).

In the processing so far, the control unit 121 ends the decoding processing of the inter-MBs then sifts to the processing for the intra-MBs.

If the control unit 121 does not determine the end of the slice (NO in Block S107), the control unit 121 determines whether or not the macro block is the intra-MB (Block S108). If the control unit 121 determines that the macro-block is the intra-MB (YES in Block S108), the control unit 121 performs the decoding processing of the intra-MB (Block S109). In this case, if there are intra-MBs capable of being processed in parallel, the control unit may perform parallel processing. Next, the control unit 121 shifts the signal processing position to the next MB (block S110), and continues the processing up to the end of the slice.

In Block S107, if the control unit 121 determines the end of the slice (YES in Block S107), the control unit 121 instructs block processing at the current slice to the deblocking processing unit 123 (Block S111).

If the control unit 121 determines the end of the stream (YES in Block S112), the control unit 121 ends the block processing, and if the control unit 121 does not determine the end of the stream, the control unit 121 shifts to Block S101 to repeat the processing.

As mentioned above, according to the embodiment, the decoding device may determine the inter-MBs from the slice data included in the moving image stream, and may perform parallel processing of the decoding of the inter-MBs in first.

It is our intention that the invention be not limited to the specific details and representative embodiments shown and described herein, and in an implementation phase, this invention may be embodied in various forms without departing from the spirit or scope of the general inventive concept thereof. Various types of the invention can be formed by appropriately combining a plurality of constituent elements disclosed in the foregoing embodiments. Some of the elements, for example, may be omitted from the whole of the constituent elements shown in the embodiments mentioned above. Further, the constituent elements over different embodiments may be appropriately combined.

The present invention is made by taking such circumstances into account, and an object of the invention is to provide a decoding device and a decoding method configured to detect inter-macro-blocks included in a moving image stream to apply decode processing in parallel to the inter-macro-blocks.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A decoding device, comprising:
an input module configured to input a stream of moving image data comprising a plurality of images, wherein each image is encoded in macro-blocks of n×n pixels divided in a matrix shape;
a detection module configured to analyze information of a slice comprising more than one macro-block and to detect inter-macro-blocks in the slice;
two or more decoding modules configured to decode the stream of moving image data in macro-blocks; and
a control module configured to cause at least one of the decoding modules to decode intra-macro-blocks in the slice after causing the two or more decoding modules to decode the inter-macro-blocks in the slice in parallel.

2. The decoding device of claim 1, wherein the control module is configured to detect the inter-macro-blocks from the slice comprising the intra-macro-blocks and the inter-macro-blocks.

3. The decoding device of claim 1, wherein the detection module is configured to continue to detect the inter-macro-blocks up to the end of the slice.

4. The decoding device of claim 1, further comprising a deblocking module configured to execute deblocking filter processing for reducing block distortion to each macro-block decoded by the two or more decoding modules, wherein the control module is configured to perform deblocking filter processing of a current slice after detecting the inter-macro-blocks up to the end of the slice.

5. A decoding method of a decoding device comprising two or more decoding processing modules, comprising:
inputting a stream of moving image data comprising a plurality of images, wherein each image is encoded in macro-blocks of n×n pixels divided in a matrix shape;
analyzing information of a slice comprising more than one macro-block and detecting inter-macro-blocks in the slice; and
causing at least one of the two or more decoding processing modules to decode intra-macro-blocks in the slice after causing the two or more decoding processing modules to decode the inter-macro-blocks in the detected slice in parallel.

6. The decoding method of claim 5, wherein the decoding comprises detecting the inter-macro-blocks from the slice comprising the intra-macro-blocks and the inter-macro-blocks.

7. The decoding method of claim 5, wherein the decoding processing continues to detect the inter-macro-blocks up to the end of the slice.

8. the decoding method of claim 5, wherein the decoding processing applies deblocking filter processing for reducing block distortion to the slice after detecting the inter-macro-blocks up to the end of the slice.
